(19) United States
(12) Patent Application Publication
(10) Pub. No.: US 2007/0271850 A1
(43) Pub. Date: Nov. 29, 2007

(54) Self-contained motorized lift-slide panel

(76) Inventor: Brad Mickelson, San Diego, CA (US)

Correspondence Address: GORDON & REES LLP, 101 WEST BROADWAY, SUITE 1600, SAN DIEGO, CA, 92101, US

(21) Appl. No.: 11/415,634

(22) Filed: May 2, 2006

(51) Int. Cl. E05F 11/00

(52) U.S. Cl. 49/358; 49/411; 49/404

(57) ABSTRACT

In one embodiment, an automatic moving panel includes: a panel housing; a power source contained within the panel housing; a first motor contained within the panel housing and coupled to the power source; a second motor contained within the panel housing and coupled to the power source; a control circuit contained within the panel housing and coupled to the power source for controlling operation of the first and second motors; at least one first wheel extending downwardly from a bottom surface of the panel housing and coupled to the first motor, wherein the at least one first wheel is configured to be raised and lowered with respect to the bottom surface of the panel housing in response to mechanical forces generated by the first motor; and at least one second wheel extending downwardly from the bottom surface of the panel housing and coupled to the second motor, wherein the at least one second wheel automatically rotated in response to mechanical forces generated by the second motor, thereby moving the panel housing in a desired direction.

### BACKGROUND OF THE INVENTION

1. Field of the Invention

The present invention relates generally to automatic sliding doors and panels and, more particularly, to automatic sliding doors and panels wherein the lifting and sliding mechanisms and motors are fully contained and concealed within the housing of the doors or panels.

2. Description of Related Technology

Existing automatic sliding doors and panels typically have a large motor and power assemblies located externally to the door, which impart a mechanical force upon the door or panel so as to drive the door/panel along a track located under the door or panel. As used hereinafter, the term “panel” shall be used to encompass doors, windows, panels or other moveable structures that can open and close to provide access to a room or area of a building. Most conventional automatic sliding panels have undercarriage wheels, which roll on top of one or more tracks to provide gliding motion to the sliding doors. Such conventional automatic sliding panels, however, are powered by bulky motor assemblies located externally to the housing of the panels. These large external motor assemblies make such conventional automatic panels unsuitable for use in residential applications and even some commercial applications where aesthetics are an important factor and/or space is limited.

### SUMMARY OF THE INVENTION

The present invention addresses the above and other needs by providing an automatic gliding or sliding panel having its motor assembly contained within the housing or frame of the panel such that they are not visible.

In one embodiment, the automatic sliding panel has the appearance of a typical manual sliding panel but is automatically operated via remote control or other external controls (e.g., a wall mounted control unit) to open and close automatically.

In one embodiment, an automatic moving panel includes: a panel housing; a first motor contained within the housing; and at least one wheel coupled to the housing and projecting outwardly from a bottom surface of the housing, wherein the first motor drives rotation of at least one of the plurality of wheels to move the panel in a desired direction.

In another embodiment, an automatic moving panel includes: a panel housing; a first motor contained within the panel housing; a second motor contained within the panel housing; a processing or control circuit contained within the panel housing for controlling operation of the first and second motors; at least one first wheel extending downwardly from a bottom surface of the panel housing and coupled to the first motor, wherein the at least one first wheel is configured to be raised and lowered with respect to the bottom surface of the panel housing in response to mechanical forces generated by the first motor; and at least one second wheel extending downwardly from the bottom surface of the panel housing and coupled to the second motor, wherein the at least one second wheel automatically rotates in response to mechanical forces generated by the second motor, thereby moving the panel housing in a desired direction.

### BRIEF DESCRIPTION OF THE DRAWINGS

FIG. 1 illustrates a perspective front view of an automatic sliding panel, in accordance with one embodiment of the invention.

FIG. 2 illustrates a perspective view of an internal motor and power assembly configured to be placed inside the housing or frame of a panel, in accordance with one embodiment of the invention.

FIG. 3 illustrates a perspective view of the motor and gear assembly for lifting the automatic panel, in accordance with one embodiment of the invention.

FIG. 4 illustrates a side view of the motor and gear assembly of FIG. 3.

FIGS. 5A and 5B illustrate side views of a first wheel set in un-lifted and lifted states, respectively, in accordance with one embodiment of the invention.

FIGS. 6A and 6B illustrate side views of a second wheel set and motor assembly for providing sliding motion, in accordance with one embodiment of the invention.

FIG. 7 illustrate a cross-sectional side view of a panel frame having a battery recharging contact and an interrupt sensor, in accordance with one embodiment of the invention.

FIG. 8 illustrates a side view of a leading edge of a panel frame and a laser or infrared (IR) light sensor oriented vertically with respect to the panel frame, in accordance with one embodiment of the invention.

FIG. 9 illustrates a block diagram of an internal power and control unit, in accordance with one embodiment of the invention.

### DETAILED DESCRIPTION OF THE PREFERRED EMBODIMENTS

Exemplary embodiments of the invention are described in detail below with reference to the figures, wherein like elements are referenced with like numerals throughout. The figures are not necessarily drawn to scale and do not necessarily show every detail or structure of the various embodiments of the invention but, rather, illustrate exemplary components and mechanical features in order to provide an enabling description of such exemplary embodiments.

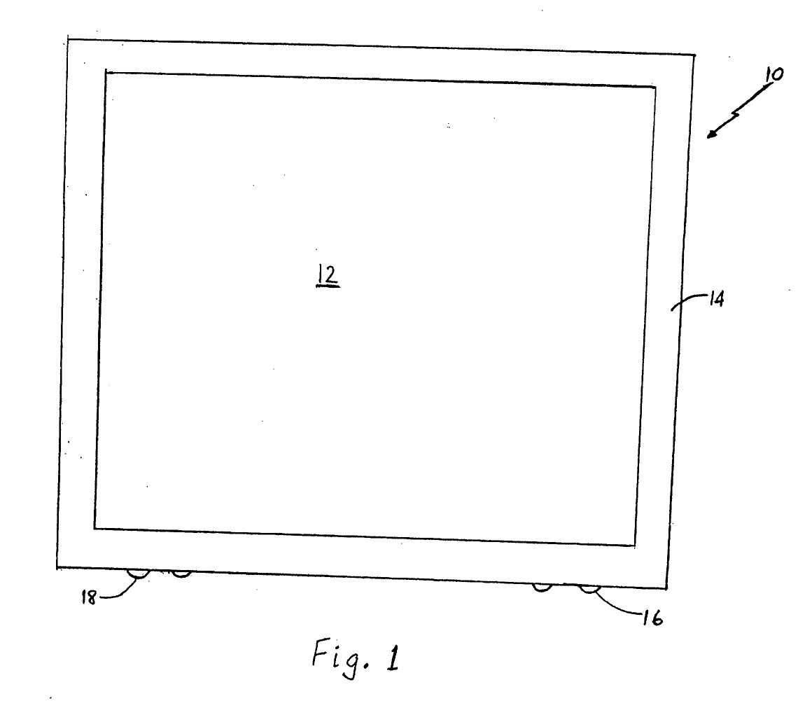

FIG. 1 illustrates a perspective front view an automatic sliding panel 10, in accordance with one embodiment of the invention. In one embodiment, the automatic sliding panel 10 includes a glass window 12 contained within a surrounding support frame 14. The support frame 14 can be made from any suitable rigid material such as, but not limited to, wood, wood composite, metal, metal alloy, plastic, or any combination thereof. Additionally, in other embodiments, the glass window 12 may be replaced with a piece made from any other suitable material (e.g., wood, wood composite, metal, metal alloy, plastic, or any combination thereof) and may be fixed to or integral with the support frame 14 so as to provide a single-piece panel 10. In some embodiments, the panel 10 may be part of a multi-panel system, each panel being capable of being automatically lifted and/or moved as described herein.

As shown in FIG. 1, the automatic sliding panel 10 further includes a first wheel set 16 and a second wheel set 18, each set having two wheels extending downwardly from a bottom cavity or channel (not shown) located at a bottom portion of the support frame 14. In one embodiment, the wheels of the first and second wheel sets 14 and 16, respectively, may be conventional track wheels configured to receive and roll on top of a conventional track (not shown) that is secured to or embedded into a top surface of a floor (not shown). As explained in further detail below, in one embodiment, the first and second wheel sets 16 and 18 automatically lift the entire panel 10 a quarter of an inch, for example, and thereafter automatically rotate in a desired direction so as to provide sliding motion to the panel 10, without any bulky external motor assembly that is visible outside of the housing of the panel 10.

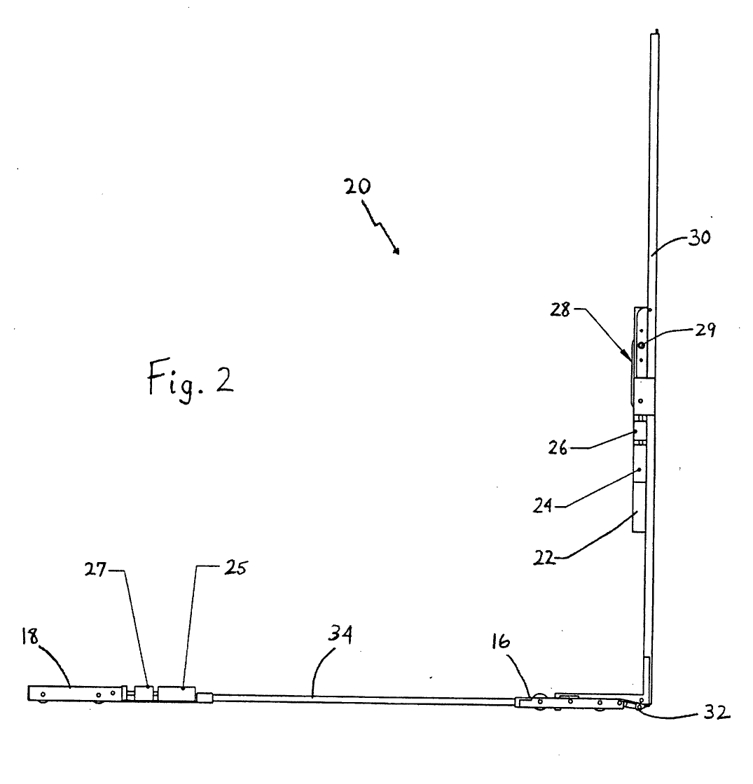

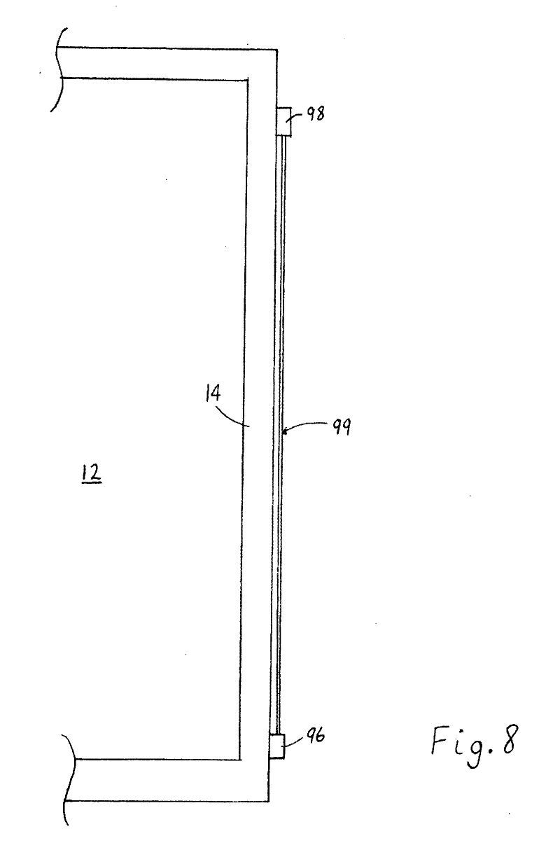

FIG. 2 illustrates a perspective view of a motor, power and control assembly 20 configured to be placed within the frame 14 of the panel 10 of FIG. 1, in accordance with one embodiment of the invention. The assembly 20 includes a power and control unit 22 that controls and provides power to a motor 24. As explained in further detail below with respect to FIG. 8, in one embodiment, the power and control unit 22 includes a rechargeable battery and a microcontroller or microprocessor for controlling the operation of the motor 24. In alternative embodiments, the power and control unit 22 and/or a battery or power source need not be located within the housing of the panel 10. In such embodiments, for example, power can be provided to one or more motors contained within the panel housing 14 by means of electrical contacts (not shown) located externally to the housing 14 and configured to make continuous electrical contact with an electrical conductor (not shown) that is electrically connected to an external power source and control circuit (not shown). For example, an electrical conductor may be located on top and/or bottom rails or tracks (not shown) along which external contacts can slide to provide continuous electrical connectivity to a power source and/or control circuitry that is electrically coupled to the electrical conductor. In this way, one or more motors located within the panel housing 14 can be controlled and/or powered by an external power source and control circuitry. In other embodiments having multiple panels that move together, a power source may be located only in one the panel housings or, alternatively, external to all the panel housings. In one embodiment, multiple panels can move and/or be lifted together or sequentially. Such multiple panels are mechanically and electrically coupled to one another via electrical contacts (not shown). When the multi-panel door system is in the closed position, the electrical contacts complete or close electrical circuits from door panel to door panel, thereby charging batteries located in each door. As the door system opens, any wired connections between door panels are opened.

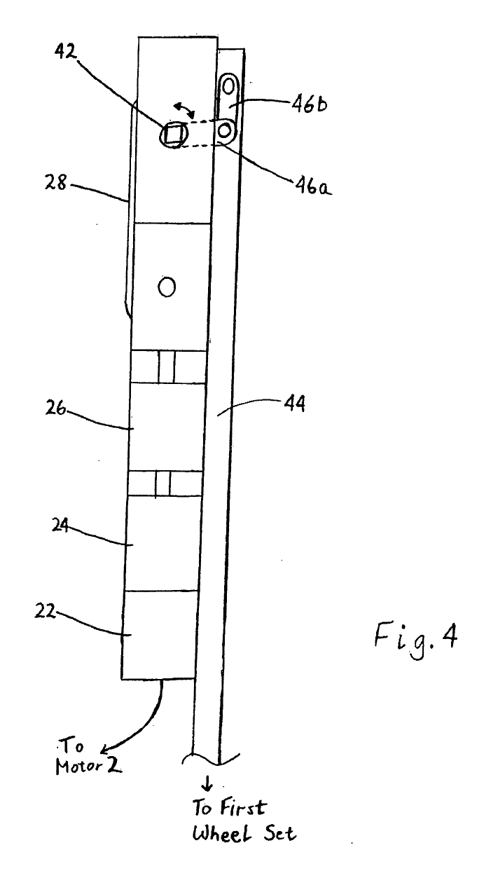

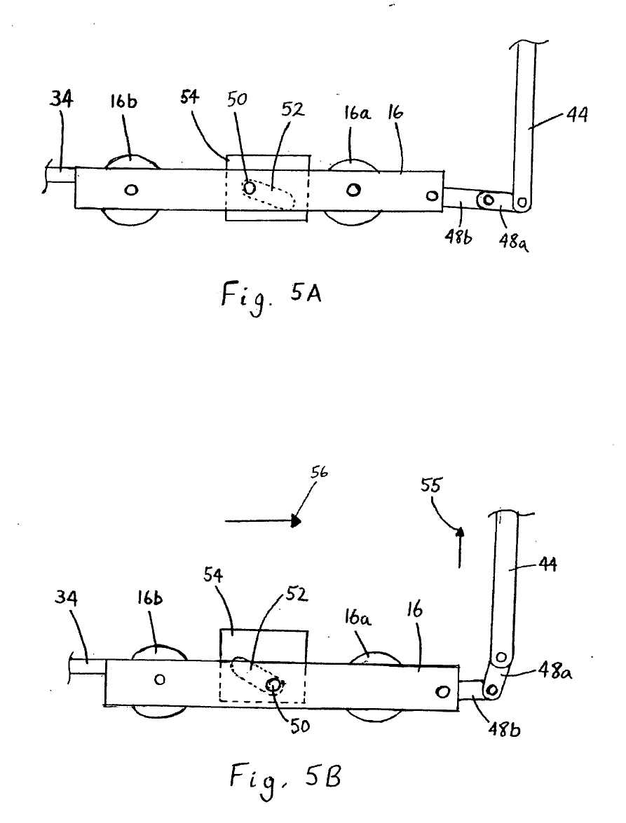

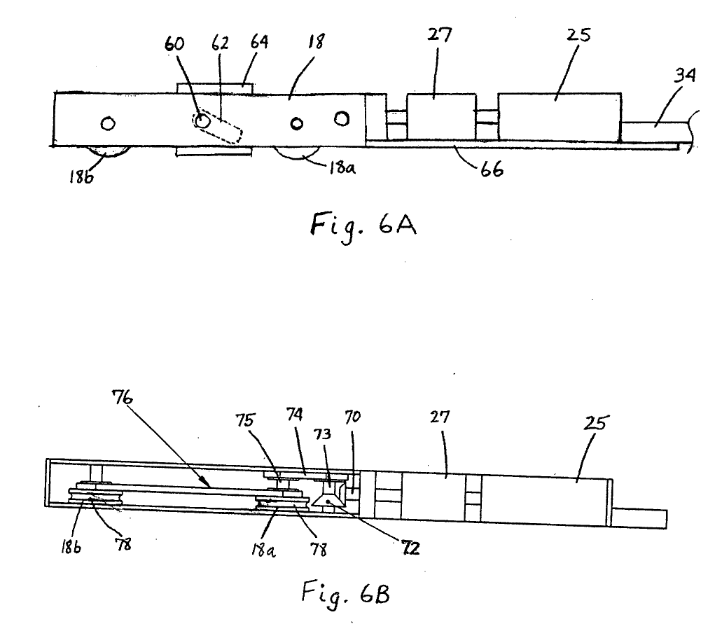

The motor 24 may be any suitable electric motor and, in one embodiment, is similar to conventional electric powered motors found in electric drills and screwdrivers. In one embodiment, the motor 24 may incorporate a servo motor having markings or other indicators that can be viewed by optical or electrical encoders (not shown) for tracking, monitoring and controlling the number of rotations of a gear assembly actuated by the motor 24, thereby monitoring the status (e.g., open or closed), position and speed of the panels. The encoder can than communicate this information to a microcontroller contained within the control unit 22. Such servo motors and encoders are well known in the art. The motor 24 is coupled to a gear assembly 26 that translates the rotational force provided by the motor 24 into a desired gear ratio, torque and/or speed to effectuate movement of a drive chain or belt 28, which in turn rotates a lever 29. When the lever 29 (e.g., a rotating cam) rotates, it lifts or lowers a vertical coupling rod 44 (FIG. 4) located within the vertical rod housing 30. The vertical coupling rod 44 is attached to a pivoting coupler 32, which couples the vertical coupling rod 44 to the first wheel set 16. The first wheel set 16 is coupled to the second wheel set 18 and a second motor assembly 25, 27, via a horizontal linking rod 34. As explained in further detail below with respect to FIGS. 5A, 5B, 6A and 6B, when the vertical coupling rod 44 is raised, the first and second wheel sets 16 and 18 are lowered with respect to a bottom of the panel frame 14, thereby raising the panel 10 higher above the top surface of a floor. In one embodiment, the panel 10 is raised ⅛ to ¼ of an inch above its normal resting position so as to eliminate any contact and/or reduce friction between a bottom surface of the panel frame 14 and a top surface of the floor, thereby facilitating a smooth gliding action as the wheels of the first and second wheel sets 14 and 16, respectively, roll on the track.

The second motor assembly includes a second motor 25 and a second gear box 27 coupled to the second motor 25. The second motor 25 is electrically coupled to the power and control unit 22 via an electrical cable (not shown). In one embodiment, the second motor 25 can comprise a servo motor and optical or electrical encoders, as discussed above, which are well known in the art. The optical or electrical encoders communicate with a microcontroller or microprocessor 102 in the power and control unit 22 to enable the microcontroller or microprocessor 102 to monitor and control the movement of the one or more panels. The power and control unit 22 turns the second motor on and off and controls the speed and direction of rotation of the second motor 25. The gear assembly 27 translates the electromotive force provided by the second motor 25 into a desired torque and/or speed (e.g., revolutions per minute (rpm)). As described in further detail below with reference to FIGS. 6A and 6B, the second motor 25 and gear assembly 27 provide a rotating force to the wheels of the second wheel set 18 such that they roll in a desired direction and speed on top of a track (not shown) in order to automatically open and close the panel 10.

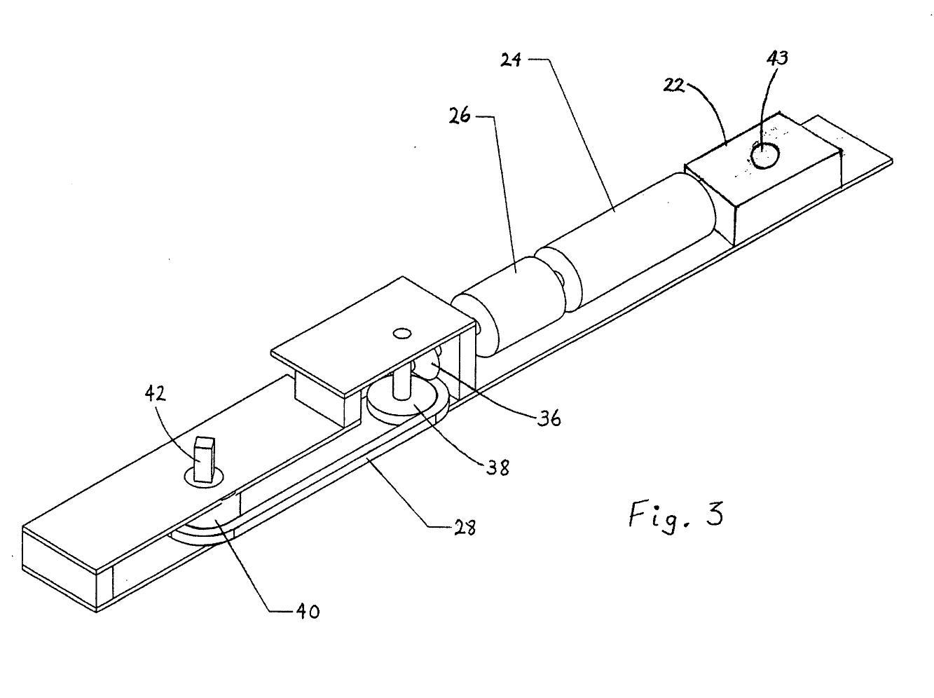

FIG. 3 illustrates a perspective view of a panel lifting mechanism, in accordance with one embodiment of the invention. The panel lifting mechanism includes the power and control unit 22, the first motor 24, the first gear box 26, a first toothed gear 36 for engaging a second toothed gear 38, the drive belt or chain 28 coupled between the second toothed gear 38 and a third toothed gear 40. In alternative embodiments, the drive belt or chain 28 may be replaced by gears or other suitable and well known engagment mechanisms. In one embodiment, the power and control unit 22 includes a wireless (e.g., infrared) signal receiver 43 for receiving a wireless control signal from a remote control unit (not shown). The remote control unit can be either a handheld unit or a wall mounted unit (e.g., keypad) that can send a signal to the power and control unite 22. The control signal can provide commands such as open, close or stop, for example, to the power and control unit 22, which in turn controls operation of the automatic panel 10 in accordance with the commands. In one embodiment, the invention utilizes infrared signal transmitters and receivers, such as those used to control television sets, for example, which are well know in the art. In alternative embodiments, a remote control unit can communicate with the power and control unit via radio frequency (RF) telemetry (e.g., bluetooth, FM, AM, etc.) and/or inductive coupling. Such wireless communication techniques, devices and protocols are well-known in the art. These and other wireless communication techniques may be used in accordance with the present invention to provide control signals to the power and control unit 22. In alternative embodiments, a mounted wall unit may wirelessly, or via hardwire connections, communicate with a microcontroller or other control circuitry that controls operation of the motors 24 and 25.

In one embodiment, when the power and control unit 22 receives a command to open or close the panel 10, for example, the power and control unit 22 will provide a pre-specified DC current having a first polarity to the first motor 24, which in turn provides a rotating force to gear box 26. The gear box 26, via internal gear mechanisms that are well-known in the art, translates the rotational force of the first motor 24 into a desired speed and torque, which in turn is imparted onto the first toothed gear 36. The rotation of the first toothed gear 36 is translated into rotation of the second toothed gear 38, which engages the first toothed gear 36. The rotation of the second toothed gear 38 causes the drive belt 28 to rotate, which in turn causes the third gear or wheel 40 to rotate. A lever 42 (e.g., rotating cam) is coupled to the third gear 40 and rotates when the third gear 40 rotates.

As shown in FIG. 4, when the lever 42 rotates, it causes the vertical coupling rod 44 to be raised or lowered when the lever 42 is rotated counter-clockwise or clockwise, respectively. The vertical coupling rod 44 is coupled to the lever 42 via a pivoting coupler 46 having a first member 46a attached to the lever 42 at one end and pivotally attached to a second member 46b at a second end. The second member 46b is pivotally attached, at its opposite end, to the vertical coupling rod 44. When the lever 42 is rotated counter-clockwise by approximately a quarter or half turn, for example, the first member 46a swings counter-clockwise and raises the second member 46b vertically upward, thereby moving the vertical coupling rod 44 upwardly.

Referring to FIG. 5A, the vertical coupling rod 44 is pivotally attached to a pivoting coupler 48 having a first member 48a pivotally attached to a second member 48b. The second member 48b is in turn attached to the first wheel set 16 having first and second wheels 16a and 16b, respectively. The housing of the first wheel set 16 further includes a lift pin 50 slidably positioned within a slanted slot 52 formed in a slot frame 54, which is securely fixed to a bottom portion of the frame 14 (FIG. 1) of the panel 10 (FIG. 1). As shown in FIG. 5B, when the vertical coupling rod 44 is moved in the upward direction as indicated by arrow 55, a first end of the first member 48a is pulled upwardly and a second end of the first member 48a swings counter-clockwise, pulling the second member 48b and the first wheel set 16 in the direction of the arrow 56.

Referring to FIG. 5B, when the first wheel set 16 is pulled to the right as indicated by arrow 56, the lift pin 50 slides downwardly and to the right of slanted slot 52. Because the slot 52 and slot frame 54 is fixed with respect to the panel frame 14, the first wheel set is forced to move downwardly and away from a bottom portion of the panel frame 14, thereby lifting the panel frame 14 by an amount equal to the vertical distance traveled by the lift pin 50 within the slanted slot 52.

In one embodiment, at the end of an “open” or “close” operation, or when the power and control unit 22 receives a “stop” command, for example, the panel 10 is automatically lowered to its resting position. To perform this lowering operation, in one embodiment, the lever 42 (FIG. 3) is caused to rotate approximately a quarter to half turn in the clockwise direction, which in turn causes the vertical coupling rod 44 to move downwardly in the direction opposite of arrow 55. As the vertical coupling rod 44 moves downwardly, the pivoting coupler 48 pushes the first wheel set 16 to the left, opposite the direction of arrow 56. As the first wheel set 16 is pushed to the left, the lift pin 50 slides upwardly and to the left in the slanted slot 52. The first wheel set recedes 16 back into a cavity (not shown) located at a bottom surface of the panel frame 14, thereby lowering the panel 10 with respect to a top surface of the floor.

Referring to FIG. 6A, the second wheel set 18, the second motor 25 and second gear assembly 27 is coupled to the first wheel set 16 via the horizontal linking rod 34. Thus, when the first wheel set 16 moves downwardly and to the left, as described above, the second wheel set 18, and the second motor and gear assembly 25, 27, also moves downwardly and to the left. As shown in FIG. 6A, the second wheel assembly 18 also includes a second lift pin 60, slidably located in a second slanted slot 62 provided in a second slot frame 64. The second lift pin 60, second slanted slot 62 and second slot frame 64 operate in similar fashion as the first lift pin 50, first slanted slot 52 and slot frame 54 described above with respect to FIGS. 5A and 5B to raise and lower the second wheel set 18 with respect to the panel frame 14, thereby lowering and lifting the panel 14.

In one embodiment, the second motor 25 and second gear assembly 27 are secured to a top surface of a rigid metal platform 66, which is securely fixed to the housing of the second wheel set 18. Therefore, the second motor 25 and gear assembly 27 are fixedly coupled to the second wheel set 18. As shown in FIG. 6A, the second wheel set 18 includes two track wheels 18a and 18b, configured to receive and roll on a track (not shown). In one embodiment, the second motor 25 is similar to electrical motors found in conventional electric power drills or screwdrivers. However, one of skill in the art can easily design a custom electric motor having alternative configurations, desired power consumptions, torques and rotation speeds, without undue experimentation. For example, in an alternative embodiment, the motor could be fixed to the frame 14 and have a mechanical drive train that couples the motor to the wheels 18. The second motor 25 may be electrically coupled to the power and control unit 22 via any suitable electrical wire or cable (not shown). After the panel 10 has been lifted as described above, the panel 10 may be moved in either direction to open or close the panel 10. In order to move the panel 10 in either direction, the power and control unit 22 provides an electric current to the second motor 25, which then provides a rotating force to the gear assembly 27.

Referring to FIG. 6B, the rotary driving force provided by the second motor 25 is translated via internal gear ratios provided by the gear assembly 27 into a desired rotary force, having a desired torque and speed. The gear assembly 27 rotates a fourth toothed gear 70 that engages and rotates a fifth toothed gear 72. The rotation of the fifth toothed gear 72 rotates a belt or chain wheel 73 coupled to the fifth toothed gear 72, which in turn rotates a second drive belt or chain 74. The motion of the second drive belt or chain 74 causes rotation of a second belt or chain wheel 75, which is fixedly coupled to a first track wheel 18a, thereby causing the first track wheel 18a to rotate in a desired direction. The rotation of the first track wheel 18a is translated into rotation of the second track wheel 18b via a third drive belt or chain 76. Thus, the electric motor 25, which is controlled by the power and control unit 22, provides a mechanical driving force that causes the wheels 18a and 18b of the second wheel set 18 to automatically rotate in a desired direction, thereby automatically moving the panel 10 along a track (not shown) in a desired direction.

As shown in FIG. 6B, each of the first and second track wheels 18a and 18b, respectively, includes a groove 78 configured to receive a top portion of the track upon which the wheels 18a and 18b roll. Similarly, the wheels 16a and 16b of the first wheel set 16 also contain similar grooves 78. The grooves 78 assist in maintaining the wheels 16a, 16b, 18a and 18b on the track as they roll on the track. In one embodiment, the wheel sets 16 and 18, and their corresponding wheels 16a, 16b, 18a and 18b may be similar or identical to standard wheel sets and wheels for sliding panels that are commercially available, for example, from G-U Hardware, Inc. located in Newport News, Va., U.S.A. Additionally, in one embodiment, the vertical coupling rod 44 and the pivoting couplers 46 and 48 are also provided by G-U Hardware, Inc. It is understood, however, that the above embodiments are exemplary and that different mechanical configurations, components and designs can be implemented by those of ordinary skill in the art without undue experimentation.

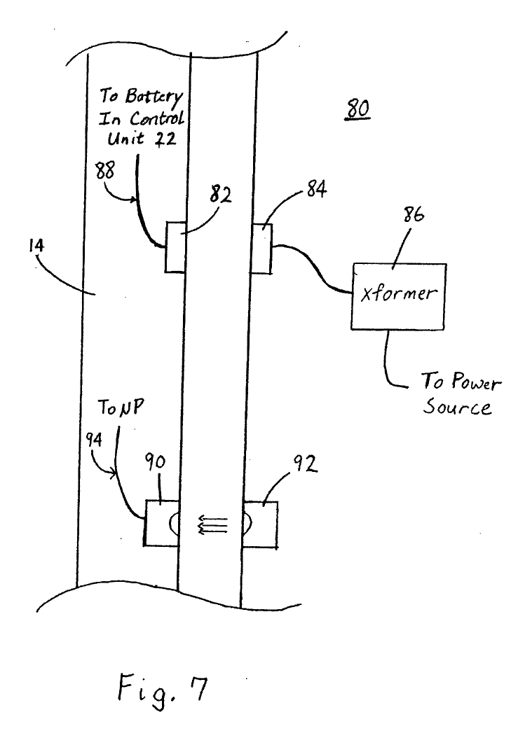

FIG. 7 illustrates a cross-sectional side view of the panel frame 14 as it moves toward a wall 80 and into a closed position. In one embodiment, the frame 14 includes an electrical contact element 82 that makes conductive contact with a corresponding contact element 84 located in a corresponding position in the wall 80. When the panel 10 is in its fully closed position, the first contact element 82 makes electrical contact with the second contact element 84 and electrical charge from a transformer 86 passes from the second contact 84 through the first contact 82 to recharge a battery (not shown) in the power and control unit 22 via a wire 88 that electrically couples the first contact element 82 to the battery. The transformer 86 is coupled to an external power source (e.g., a 120 VAC wall outlet or similar source) and converts the power from the external power source into a desired power, voltage and/or current level for recharging the battery. As discussed above, in alternative embodiments, the power and control unit 22 may be external to the housing the panel 10 and electrically coupled to one or more internal motors 24 and/or 25 via external contact elements on the housing that provide electrical coupling to the external power and control unit. In multi-panel embodiments of the invention, the power and control unit 22 or just a power source may located in the housing of another panel (not shown), which is adjacent to and moves together with panel 10. In alternative embodiments, the power and control unit 22 may be configured as to separate units (i.e., a power unit and a separate control unit).

The panel frame 14 further includes an interrupt detector 90 for detecting when an object is in the path of the panel 10 closing. In one embodiment, the interrupt detector comprises a light detector 90 that receives a light beam (e.g., laser, infrared, etc.) from a light beam transmitter 92 located in a corresponding location of the wall 80. If an object interrupts the beam of light from the transmitter 92 to the detector 90, the detector 90 sends an interrupt signal to a microprocessor located in the power and control unit 22. Similar light detectors and receivers are well known in the art and used to interrupt the closing of garage panels, for example. In other embodiments, the interrupt detector comprises a motion sensor which is well known in the art. Upon receiving the interrupt signal, the power and control unit 22 will stop the automatic panel 10 from closing any further until the object in the path of the panel 10 is removed and a “resume operation” signal is received from the light detector 90 and/or another command is received by the microprocessor via remote control.

FIG. 8 illustrates another embodiment of a light or radiation detector 96 in accordance with a further embodiment of the invention. In various embodiments the light or radiation that is emitted and detected can be an infrared or laser light. As shown in FIG. 8, the light detector 96 is oriented vertically along a leading edge of the panel frame 14 and is configured to receive an light 99 from a corresponding light emitter 98, which is also located on the leading edge of the panel frame 14 above the light detector 96. With this vertical detector configuration, if a person or object breaks the light beam 99 along any height of the leading edge of the panel frame 14, the detector 96 sends an interrupt signal to the power and control unit 22, which will then stop the automatic panel 10 from further movement. In alternative embodiments, any type of electromagnetic radiation or light source and detector may be utilized.

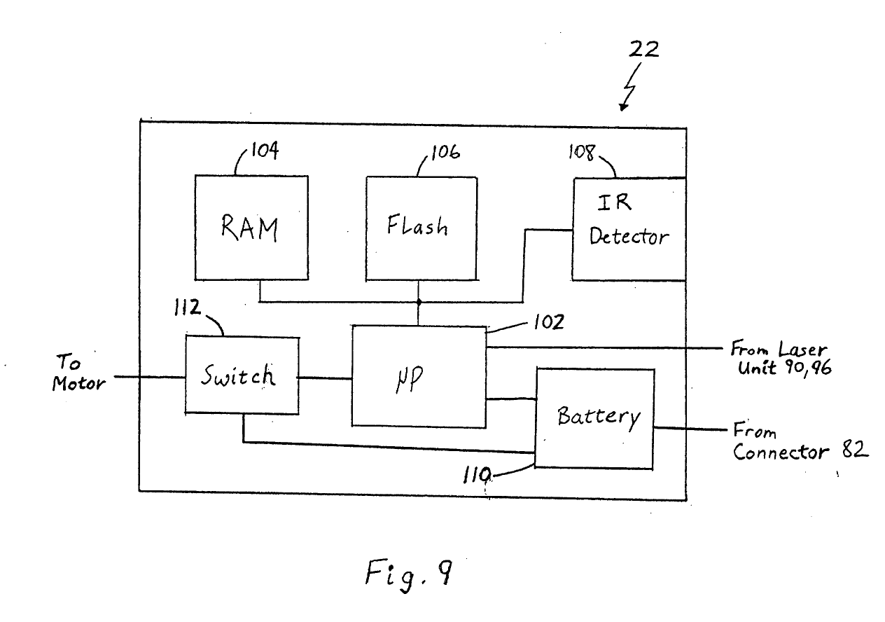

FIG. 9 illustrates a block diagram of the power and control unit 22, in accordance with one embodiment of the invention. The power and control unit 22 includes a microprocessor or microcontroller 102 for performing logic functions and controlling the operation of the automatic panel 10 as described herein. In alternative embodiments, the microprocessor 102 may be embodied as a microcontroller, application specific integrated circuit (ASIC) chip, programmable logic array or any other type of processing circuitry known in the art suitable for performing the functions described herein. In one embodiment, the microprocessor 102 may be replaced with relay circuits and switches for implementing some of the more rudimentary control functions described herein. Such relay circuits and switches are well known in the art.

In one embodiment, the power and control unit 22 further includes a random access memory (RAM) 104 for temporarily storing data and/or instructions that are executed by the microprocessor 102. In further embodiments, the power and control unit 22 further includes a reprogrammable FLASH memory 106 for storing data and program code that controls the operation of the microprocessor 102. In one embodiment, upon system start up, program code is downloaded from the FLASH memory 106 to the RAM 104 for execution by the microprocessor 102. This program code is the software that controls the operation of the microprocessor or microcontroller 102 such as how it receives and transmits signals, and controls other devices (e.g., motors 24 and 25). In one embodiment, the motors 24 and 25 include servo motors and encoders as discussed above. The encoders communicate with the microcontroller 102 to indicate the current status of the one or more panels of a panel assembly such as whether each panel is fully open or closed, or its position in between these states, lifted or not lifted, or in between these states. The servo motors can also allow monitoring of speed and direction of motor rotation. Therefore, the microcontroller can control and determine when all the panels are lifted before initiating closing or opening operations via the motor(s) 24, for example, as well as controlling the speed and direction of movement (e.g., sliding and/or lifting movement) of each panel.

It is understood that the functionality of the microcontroller or microprocessor 102 can be implemented in various ways known in the art. For example, a control circuit 102 can be implemented as a microcontroller, microprocessor, relay circuits/switchs, programmable logic gates, ASICS or other circuits known in the art. In one embodiment, a control circuit 102 can include a separate system controller (not shown) for communicating with the servo encoders and a remote control unit/wall mounted control unit, and one or motor controllers (not shown), which communicates with the system controller. The system controller, in addition to receiving operational commands (e.g., “Stop”, “open,” “close,” etc.) controls the operation of each motor controller, which in turn actuates and controls each of the motors 24, 25 in the panel assembly.

In alternative embodiment, the power and control unit 22 may comprise a rechargeable battery that supplies power to system control circuitry. The system control circuitry may comprise the microprocessor 102 discussed above or, in alternative embodiments, may simply comprise relay switches, micro switches, or other control circuits that are well known in the art for controlling the functionality described herein.

In one embodiment, the power and control unit 22 further includes an infrared (IR) light detector for receiving IR command signals from a remote control unit (not shown). In other embodiments, any means of wireless communication can be utilized two-way communication between the remote control unit and the control unit 22. The command signals include, inter alia, commands such as “open,” “close” and “stop,” for example. Upon receiving an “open” or “close” command, for example, the microprocessor 102 controls a switch 112 to provide charge/power from a power supply battery 110 to both the first and second motors 24 and 25, respectively. The power supply or battery 110 may be any type of rechargeable battery or power source known in the art such as a lithium ion or NiMH battery, for example. As explained above, power is first provided to the first motor 24 to lift the panel 10 a pre-specified distance above its normal resting position. Thereafter, power is provided to the second motor 25 to automatically drive the wheels 18a and 18b so as to automatically move the panel 10 along a track in a desired direction. The microprocessor 102 can be programmed to provide power to the respective first and second motors 24 and 25 for an appropriate duration of time in order to effectuate a desired amount of lifting and move the panel 10 a desired distance from its fully closed to fully open position, and back. Additionally, the panel 10 may be stopped at any interim position by sending a “stop” command to the microprocessor 102 via the remote control or wall-mounted control unit. Additionally, in further embodiments, the microprocessor 102 senses when the path of the panel 10 is being obstructed when it receives a interrupt signal from the light (e.g., laser) detector 90 (FIG. 7). Other means of detecting when the panel 10 is obstructed via known techniques and/or various types of sensors coupled to the microprocessor 102 may also be utilized to control operation of the panel 10. For example, garage panel openers, and other types of automatic panels, can sense when there is an object or force that is resisting the normal opening or closing of a panel. When such resistance is sensed, a conventional garage panel opener, for example, will discontinue its opening or closing operation and return the panel to its original position prior to sensing the resistance or obstruction. These and other known techniques and mechanisms may be utilized in the present invention.

While various embodiments of the invention have been illustrated and described, those of ordinary skill in the art will appreciate that the above descriptions of the embodiments are exemplary only and that the invention may be practiced with modifications or variations of the devices and techniques disclosed above. For example, in alternative embodiments, the orientation of the wheels 16a, 16b, 18a and 18b may be turned 90 degrees from the orientation shown in FIGS. 1 and 2, for example, such that the panel automatically swings open and closed, instead of sliding in a linear direction. In this embodiment of the invention, two or more wheels located at the bottom of the panel frame roll on a top surface of a floor in an arc-shaped path, instead of rolling on top of a linear track. In other embodiments, one or more panels may be configured to be automatically lifted only to allow easier manual movement of the panel along a track, for example. Alternatively, in some embodiments, it is not necessary to lift the one or more panels prior to automatically moving the one or more panels. Those of ordinary skill in the art would be able to easily modify the gear assemblies discussed above to engage and automatically rotate one or more of the wheels in this alternative embodiment. Additionally, those of ordinary skill in the art will know, or be able to ascertain and practice, using no more than routine experimentation, many equivalents to the specific embodiments of the invention described herein. Such modifications, variations and equivalents are contemplated to be within the spirit and scope of the present invention as set forth in the claims below.

What is claimed is:

1. An automatic moving panel, comprising:
a panel housing;
a first motor contained within the housing; and
at least one first wheel coupled to the housing and projecting outwardly from a bottom surface of the housing, wherein the first motor drives rotation of the at least one first wheel to move the panel in a desired direction.

2. The automatic moving panel of claim 1 further comprising a power source contained within the housing and coupled to the first motor so as to provide power to the first motor.

3. The automatic moving panel of claim 1 further comprising a gear assembly coupled to the first motor and the at least one first wheel, the gear assembly translating the mechanical force generated by the first motor into a desired rotational force applied to the at least one first wheel.

4. The automatic moving panel of claim 1 further comprising at least one second wheel and a second motor coupled to the at least one second wheel, for providing a mechanical force to lift or lower the at least one second wheel a desired distance with respect to a bottom surface of the panel housing.

5. The automatic moving panel of claim 4 further comprising a vertical coupling rod coupled to the second motor, wherein the second motor provides a mechanical force to raise or lower the vertical coupling rod, which in turn lowers or raises the at least one second wheel with respect to the bottom surface of the panel housing.

6. The automatic moving panel of claim 5 further comprising:
a lever coupled to the vertical coupling rod; and
a gear assembly for translating the mechanical force provided by the second motor into a desired rotational force applied to the lever, wherein rotation of the lever actuates vertical movement of the vertical coupling rod.

7. The automatic moving panel of claim 1 wherein the at least one first and second wheels are configured to roll on a linear track to provide linear motion to the panel.

8. The automatic moving panel of claim 1 further comprising a control circuit contained within the housing of the panel for controlling operation of the first motor.

9. The automatic moving panel of claim 8 further comprising an interrupt detector coupled to the control circuit for sensing when the movement of the panel is being hindered and sending an interrupt signal to the control circuit.

10. The automatic moving panel of claim 9 wherein said interrupt detector comprises a light beam emitter and a light beam detector both of which are vertically oriented along a leading edge of the panel housing.

11. The automatic moving panel of claim 1 further comprising:
an internal power source located within the panel housing; and
an electrical contact element located on an external surface of the panel housing and configured to make electrical contact with an external power source in order to recharge the internal power source.

12. The automatic moving panel of claim 1 further comprising a transparent window and wherein the panel housing comprises a frame that borders and receives the peripheral edges of the transparent window.

13. An automatic moving panel, comprising:
a panel housing;
a power source contained within the panel housing;
a first motor contained within the panel housing and coupled to the power source;
a second motor contained within the panel housing and coupled to the power source;
a control circuit contained within the panel housing and coupled to the power source for controlling operation of the first and second motors;
at least one first wheel extending downwardly from a bottom surface of the panel housing and coupled to the first motor, wherein the at least one first wheel is configured to be raised and lowered with respect to the bottom surface of the panel housing in response to mechanical forces generated by the first motor; and
at least one second wheel extending downwardly from the bottom surface of the panel housing and coupled to the second motor, wherein the at least one second wheel automatically rotated in response to mechanical forces generated by the second motor, thereby moving the panel housing in a desired direction.

14. The automatic moving panel of claim 13 further comprising a vertical coupling rod coupled to the first motor and the at least one first wheel, wherein the first motor provides a mechanical force to raise or lower the vertical coupling rod, which in turn lowers or raises the at least one first wheel with respect to the bottom surface of the panel housing.

15. The automatic moving panel of claim 14 further comprising:
a lever coupled to the vertical coupling rod; and
a first gear assembly for translating the mechanical force provided by the first motor into a desired rotational force applied to the lever, wherein rotation of the lever actuates vertical movement of the vertical coupling rod.

16. The automatic moving panel of claim 15 further comprising:
a first pivoting coupler coupled to the lever and the vertical coupling rod for translating rotational motion of the lever into vertical linear motion of the vertical coupling rod; and
a second pivoting coupler coupled to the vertical coupling rod and the at least one first wheel, for translating vertical motion of the vertical coupling rod into vertical motion of the at least one first wheel.

17. The automatic moving panel of claim 15 further comprising a second gear assembly coupled to the second motor and the at least one second wheel, the second gear assembly translating the mechanical force generated by the second motor into a desired rotational force applied to the at least one second wheel.

18. The automatic moving panel of claim 17 further comprising:
a first drive belt coupled to the first gear assembly and the lever for translating mechanical forces provided by the first gear assembly into rotational motion of the lever; and
a second drive belt coupled to the second gear assembly and the at least one second wheel for translating mechanical forces provided by the second gear assembly into rotational motion of the at least one second wheel.

19. The automatic moving panel of claim 13 wherein the at least one first and second wheels are configured to roll on a linear track to provide linear motion to the panel.

20. The automatic moving panel of claim 13 further comprising an interrupt detector coupled to the control circuit for sensing when the movement of the panel is being hindered and sending an interrupt signal to the control circuit.

21. The automatic moving panel of claim 20 wherein said interrupt detector comprises a light beam emitter and a light beam detector both of which are vertically oriented along a leading edge of the panel housing.

22. The automatic moving panel of claim 13 further comprising an electrical contact element located on the housing of the panel and configured to make electrical contact with an external contact element in order to recharge the power source.

23. The automatic moving panel of claim 13 further comprising a transparent window and wherein the panel housing comprises a frame that borders and receives the peripheral edges of the transparent window.

24. An automatic moving panel assembly, comprising:
at least one panel having a panel housing;
a motor contained within the panel housing; and
at least one wheel coupled to the housing and projecting outwardly from a bottom surface of the housing, wherein the motor actuates movement of the at least one wheel so as to move the at least one panel in a desired direction.

25. The automatic moving panel assembly of claim 24 wherein the motor lowers the at least one wheel with respect to a bottom surface of the panel housing so as to lift the panel housing as desired distance from a top surface of a floor.

26. The automatic moving panel assembly of claim 24 wherein the motor rotates the at least one wheel so as to move the at least one panel housing horizontally with respect to a top surface of a floor.

27. The automatic moving panel assembly of claim 24 further comprising a power and control unit located inside of the panel housing.

28. The automatic moving panel assembly of claim 24 further comprising an interrupt detector coupled to the control circuit for sensing when the movement of the panel is being hindered and sending an interrupt signal to the control circuit.

29. The automatic moving panel assembly of claim 28 wherein said interrupt detector comprises a light beam emitter and a light beam detector both of which are vertically oriented along a leading edge of the panel housing.

30. The automatic moving panel assembly of claim 24 wherein the at least one panel comprises a plurality of panels that are coupled together and move together is the desired direction.
